(19) United States
(12) Patent Application Publication
(10) Pub. No.: US 2026/0349103 A1
(43) Pub. Date: Nov. 5, 2026

(54) PERIMETER DETECTION USING UWB

(71) Applicant: Ford Global Technologies, LLC, Dearborn, MI (US)

(72) Inventors: Ivan Vukovic, Birmingham, MI (US); Jean de Dieu MUTANGANA, Detroit, MI (US); Sathyanarayana Chary Palakonda, Northville, MI (US); Sanketh Venkatesh Prasad, Bloomington, IL (US)

(21) Appl. No.: 19/197,269

(22) Filed: May 2, 2025

(51) Int. Cl. G01S 13/50; B60Q 1/50; B60Q 5/00; B60Q 9/00; G01S 7/00; G01S 13/02; H04W 4/40; H04W 4/80

(52) U.S. Cl. CPC G01S 13/50; B60Q 5/005; B60Q 9/00; G01S 7/003; G01S 13/0209; H04W 4/40; H04W 4/80; B60Q 1/50

(57) ABSTRACT

Ultrawide band (UWB) perimeter detection provided by a vehicle using UWB-enabled auxiliary devices is extended using auxiliary devices. A controller of a vehicle receives, from one or more auxiliary devices located outside of and in communication with the vehicle, radar sensing data indicative of motion detected by each of the respective one or more auxiliary devices. The controller receives, from one or more UWB anchors located on the vehicle, UWB radar data indicative of motion detected by the UWB anchors. The controller fuses the radar sensing data from the one or more auxiliary devices with the UWB radar data from the one or more UWB anchors to detect motion within a defined perimeter around the vehicle. In response to detecting motion within the defined perimeter, the controller initiates a predefined response action.

### TECHNICAL FIELD

Aspects of the disclosure generally relate to extending ultrawide band (UWB) perimeter detection provided by a vehicle using UWB-enabled auxiliary devices.

### BACKGROUND

Phone trilateration using UWB technology is a method for precise location tracking and positioning. UWB uses very short pulses over a wide frequency spectrum, allowing for accurate distance measurements. In trilateration, the position of a device is determined by calculating the distances from three or more known reference points, typically UWB anchors. The device measures the time it takes for UWB signals to travel between it and each UWB anchor, converting these time-of-flight measurements into distance estimates. By using multiple distance measurements, the exact position of the device can be pinpointed, often within a few centimeters. This method is used in applications such as indoor navigation, asset tracking, and augmented reality.

Channel impulse responses (CIRs) may be used to provide radar functionality, in systems utilizing UWB technology. CIRs may represent a time-domain response of a signal as it travels through a channel, capturing the reflections, diffractions, and scattering of the signal off objects in the environment. By analyzing the CIRs, the presence, distance, and velocity of objects may be identified.

### SUMMARY

In one or more illustrative examples, a method for extending ultrawide band (UWB) perimeter detection provided by a vehicle using UWB-enabled auxiliary devices includes: receiving, to a controller of a vehicle from one or more auxiliary devices located outside of and in communication with the vehicle, radar sensing data indicative of motion detected by each of the respective one or more auxiliary devices; receiving, from one or more UWB anchors located on the vehicle, UWB radar data indicative of motion detected by the UWB anchors; fusing the radar sensing data from the one or more auxiliary devices with the UWB radar data from the one or more UWB anchors to detect motion within a defined perimeter around the vehicle; and in response to detecting motion within the defined perimeter, initiating a predefined response action.

In one or more illustrative examples, the method further includes establishing a BLUETOOTH Low Energy (BLE) communication session with each of the one or more auxiliary devices located outside the vehicle, the BLE communication session being used for sending commands to the respective one or more auxiliary devices and for receipt of the radar sensing data, the commands including a command to initiate use of the one or more auxiliary devices for radar sensing.

In one or more illustrative examples, the method further includes identifying physical locations of the one or more auxiliary devices with respect to the vehicle using the one or more UWB anchors.

In one or more illustrative examples, the method further includes determining a schedule that includes radar time slots for the one or more auxiliary devices; and transmitting the schedule to the one or more auxiliary devices, wherein the one or more auxiliary devices utilize the schedule to time operation of radar rounds by the one or more auxiliary devices.

In one or more illustrative examples, the predefined response action includes one or more of activating a light of the vehicle in a direction corresponding to the detected motion; sounding a horn of the vehicle; initiating a communication with priority services; and/or displaying a message via a human-machine interface (HMI) of the vehicle.

In one or more illustrative examples, the radar sensing data comprises channel impulse response (CIR) data received from each auxiliary device, and wherein the controller analyzes amplitude, delay, or multipath characteristics of the CIR data to determine a presence, motion, or trajectory of an object.

In one or more illustrative examples, the radar sensing data is processed locally by each auxiliary device to detect motion, and the detected motion is transmitted to the controller.

In one or more illustrative examples, the method further includes transmitting a stop command to the one or more auxiliary devices to terminate radar perimeter monitoring based on a condition, the condition including vehicle ignition, timeout expiration, or received user input.

In one or more illustrative examples, a vehicle for extending ultrawide band (UWB) perimeter detection using UWB-enabled auxiliary devices, includes one or more UWB anchors configured to monitor coverage areas outside the vehicle; and a controller, configured to: receive from one or more auxiliary devices located outside of and in communication with the vehicle, radar sensing data indicative of motion detected by each of the respective one or more auxiliary devices, receive, from the one or more UWB anchors, UWB radar data indicative of motion detected by the UWB anchors, fuse the radar sensing data from the one or more auxiliary devices with the UWB radar data from the one or more UWB anchors to detect motion within a defined perimeter around the vehicle, and in response to detecting motion within the defined perimeter, initiating a predefined response action.

In one or more illustrative examples, at least one of the auxiliary devices includes a UWB sensor mounted on a trailer coupled to the vehicle.

In one or more illustrative examples, at least one of the auxiliary devices includes a mobile phone paired to the vehicle.

In one or more illustrative examples, the controller is further configured to establish a BLE communication session with each of the one or more auxiliary devices located outside the vehicle, the BLE communication session for use in sending commands to the respective one or more auxiliary devices and for receipt of the radar sensing data, the commands including a command to initiate use of the one or more auxiliary devices for radar sensing.

In one or more illustrative examples, the controller is further configured to identify physical locations of the one or more auxiliary devices with respect to the vehicle using the one or more UWB anchors.

In one or more illustrative examples, the controller is further configured to determine a schedule that includes radar time slots for the one or more auxiliary devices; and transmit the schedule to the one or more auxiliary devices, wherein the one or more auxiliary devices utilize the schedule to time operation of radar rounds by the one or more auxiliary devices.

In one or more illustrative examples, the predefined response action includes one or more of to activate a light of the vehicle in a direction corresponding to the detected motion; sound a horn of the vehicle; initiate a communication with priority services; and/or display a message via a human-machine interface (HMI) of the vehicle.

In one or more illustrative examples, the radar sensing data comprises channel impulse response (CIR) data received from each auxiliary device, and the controller is further configured to analyze amplitude, delay, or multipath characteristics of the CIR data to determine a presence, motion, or trajectory of an object.

In one or more illustrative examples, the radar sensing data is processed locally by each auxiliary device to detect motion, and the controller is further configured receive information indicative of the motion from the detecting auxiliary device.

In one or more illustrative examples, the controller is further configured to transmit a stop command to the one or more auxiliary devices to terminate radar perimeter monitoring based on a condition, the condition including vehicle ignition, timeout expiration, or received user input.

In one or more illustrative examples, a non-transitory computer-readable medium includes instructions for extending ultrawide band (UWB) perimeter detection provided by a vehicle using UWB-enabled auxiliary devices that, when executed by one or more computing devices, cause the one or more computing devices to perform operations including to receive from one or more auxiliary devices located outside the vehicle, radar sensing data indicative of motion detected by each of the respective one or more auxiliary devices; receive, from one or more UWB anchors, UWB radar data indicative of motion detected by the UWB anchors; fuse the radar sensing data from the one or more auxiliary devices with the UWB radar data from the one or more UWB anchors to detect motion within a defined perimeter around the vehicle; and in response to detecting motion within the defined perimeter, initiating a predefined response action.

In one or more illustrative examples, the predefined response action includes one or more of to activate a light of the vehicle in a direction corresponding to the detected motion; sound a horn of the vehicle; initiate a communication with priority services; and/or display a message via a human-machine interface (HMI) of the vehicle.

### BRIEF DESCRIPTION OF THE DRAWINGS

FIG. 1 illustrates an example perimeter detection system including a vehicle implementing UWB radar and ranging for extended UWB perimeter detection;

FIG. 2 illustrates further aspects of the controller of FIG. 1 implementing UWB radar and ranging modes;

FIG. 3A illustrates an example of the vehicle with a trailer connected at the rear.

FIG. 3B illustrates the example of the vehicle with the trailer connected at the rear and UWB coverage area provided by the UWB anchors of the vehicle;

FIG. 3C illustrates an example of the vehicle with a trailer connected at the rear with the addition of auxiliary devices in communication with the vehicle to provide additional coverage areas;

FIG. 4 illustrates an example scheduling of ranging and radar sessions between the UWB anchors and the mobile devices;

FIG. 5 illustrates an example data flow for the operation of the controller in the context of the perimeter detection system;

FIG. 6 illustrates an example process for extending UWB perimeter detection provided by a vehicle using UWB-enabled auxiliary devices; and

FIG. 7 illustrates an example computing device for implementing aspects of UWB radar and ranging.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

UWB functionality may be implemented by vehicles for purposes such as mobile device ranging and access to the vehicle. Some UWB implementation also have radar capabilities. Thus, in addition to access functions, vehicles may leverage the UWB radar capability to detect persons and objects inside or around the vehicle.

Detection of persons or objects outside the vehicle may serve as a deterrent to indicate to the owner that someone is approaching or to turn on cameras. However, in cases where the user has a trailer or is camping in a tent, that additional area outside the vehicle may not be covered or may only be partially covered by the vehicle's UWB functionality.

Aspects of the disclosure relate to utilizing UWB-based radar functionality of auxiliary devices to extend the detection perimeter around the vehicles. The auxiliary devices may include phones, aftermarket connected car consortium (CCC) devices, sensors integrated into trailers, etc. In the approach, the user may pair the auxiliary devices with the vehicle (e.g., through phone as a key or digital key pairing). Once paired, each auxiliary device may establish a data connection with the vehicle. The auxiliary devices may be placed around an area which is not already covered by the vehicle UWB anchors. The coordinates of each added auxiliary device may be determined using the vehicle's UWB anchors, global navigation satellite system (GNSS), or inertial measurement units (IMUs). In some cases, the user may manually input the location via a user interface.

Using the greater network of built-in and auxiliary devices, a controller of the vehicle may communicate a wireless schedule to the devices. Each auxiliary device added as an additional radar sensing point may emit radar transmissions in slots designated by the schedule. These radar transmissions result in CIRs which may be processed to identify motion. In the context of the present disclosure, the term motion refers to motion, presence, or movement-related changes in the environment detectable using UWB radar signals, including but not limited to displacement of objects, approach of persons or animals, or changes in CIR patterns indicating movement within the defined perimeter. As used herein, radar sensing data refers to motion detection output generated by vehicle-mounted UWB anchors and/or by auxiliary devices in communication with the vehicle. Both may include raw CIR data or processed motion events, and are collectively referred to as radar detection data.

The motion may be reported to the controller along with the distance to the detected motion. The controller on the vehicle may fuse the input from the auxiliary devices that provide supplemental radar along with the on-vehicle UWB anchors to determine if the movement is within the defined perimeter. The controller may do so by aligning timestamps, comparing motion vectors, and filtering noise or redundant detections to determine if the movement is within the defined perimeter.

If motion is detected, the controller may perform various actions such as: activate a horn, activate lights in the direction of the motion, begin playing music or audio at specific frequencies, initiate a call to priority services, or some other preprogrammed action. The specific response action may be selected based on user-defined rules, motion type, device origin, or detected direction of movement. The controller may prioritize certain responses based on proximity or duration of the detected motion.

The defined perimeter may be determined by the controller using a combination of user input, ranging measurements, or predefined coverage zones. In some examples, the perimeter is automatically computed based on the locations of auxiliary devices relative to the vehicle. In some examples, the perimeter may be determined based on sensing of the surroundings of the vehicle and/or baselining via radar. For instance, an ego vehicle may park and activate radar mode based on an initial broad perimeter, but if another vehicle shows up and parks next to it, the ego vehicle may reduce the perimeter size to be closer to the ego vehicle. In another example, the perimeter may be increased if a vehicle that was parked next to the ego vehicle drives away. In yet another example, a reduction in the perimeter may be performed if the user parks next to a wall. Further aspects of the disclosure are discussed in detail herein.

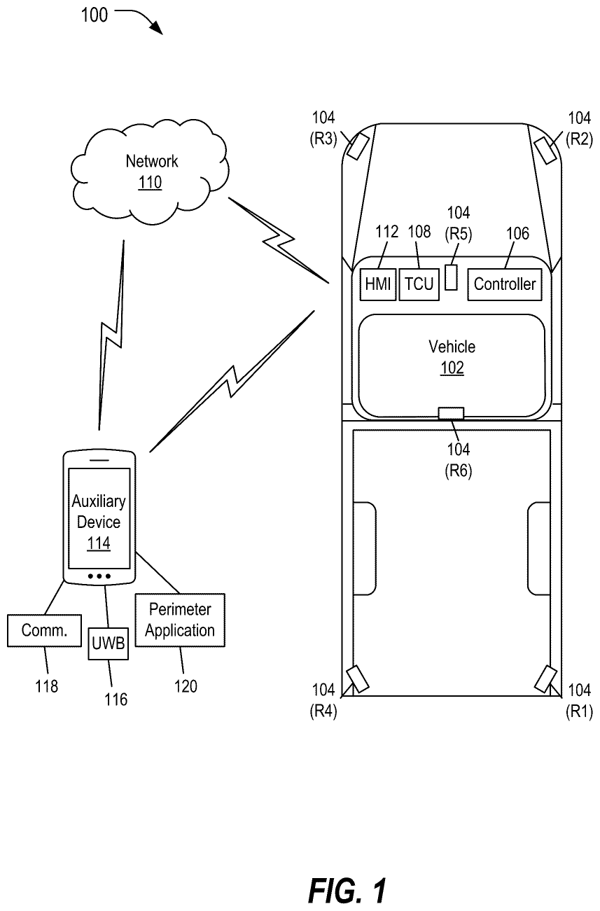

FIG. 1 illustrates an example perimeter detection system 100 including a vehicle 102 implementing UWB radar and ranging for extended UWB perimeter detection. As shown, the vehicle 102 includes a plurality of UWB anchors 104, a controller 106, a telematics control unit (TCU) 108 in communication with a communications network 110, and a human-machine interface (HMI) 112. The perimeter detection system 100 may further include one or more auxiliary devices 114 outside of the vehicle 102 configured to support extended UWB perimeter detection. The auxiliary devices 114 may include device UWB 116 functionality and a network controller 118 configured to wirelessly communicate with the vehicle 102. The auxiliary devices 114 may also execute a perimeter application 120 to aid in the extended UWB perimeter detection. It should be noted that the illustrated perimeter detection system 100 is only an example, and perimeter detection systems 100 including more, fewer, and differently located elements may be used.

Referring more specifically to FIG. 1, the vehicle 102 may be any passenger or commercial automobile such as a car, a truck, a sport utility vehicle, a crossover, a van, a minivan, a taxi, a bus, etc. The vehicle 102 may include various types of automobile, crossover utility vehicle (CUV), sport utility vehicle (SUV), truck, recreational vehicle, motorcycle, boat, plane or other mobile machine for transporting people or goods. Such vehicles 102 may be human-driven or autonomous. In many cases, the vehicle 102 may be powered by a gasoline, diesel, or hydrogen engine. As another possibility, the vehicle 102 may be a battery electric vehicle (BEV) powered by one or more electric motors. As a further possibility, the vehicle 102 may be a hybrid electric vehicle (HEV) powered by both an engine and one or more electric motors, such as a series hybrid electric vehicle, a parallel hybrid electrical vehicle, or a parallel/series hybrid electric vehicle.

The UWB anchors 104 may communicate wirelessly with the auxiliary devices 114 using radio waves. The UWB anchors 104 use an ultra-wideband signal, e.g., a signal with a low energy level spread over a wide frequency channel resulting in very low power spectral density level. The Federal Communications Commission and the International Telecommunications Union Radiocommunication Sector define ultra-wideband as an antenna transmission for which emitted signal bandwidth exceeds the lesser of 500 MHz or 20% of the arithmetic center frequency. The UWB anchors 104 may use any suitable modulation method, e.g., orthogonal frequency-division multiplexing (OFDM), phase-shift keying (PSK), pulse-position modulation (PPM), etc.

To enable robust user localization, the vehicle 102 may be equipped with UWB responders that are strategically positioned in the interior of the vehicle 102 and within the body structure to provide UWB network coverage of the environment in and around the vehicle 102, e.g., where the auxiliary device 114 of the user may be located. Depending on the physical design and shape of the vehicle 102, some of the UWB anchors 104 may be placed inside the body walls of the vehicle 102 (e.g., four respectively placed near or/at each corner of the front and rear bumpers of the vehicle 102), center console (e.g., between the driver and passenger locations) and inside the upper cabin (e.g., near the front center, near the rear center).

As shown in the example of FIG. 1, six UWB anchors 104 are shown. These include a first UWB anchor 104 (R1), a second UWB anchor 104 (R2), a third UWB anchor 104 (R3), a fourth UWB anchor 104 (R4), a fifth UWB anchor 104 (R5), and a sixth UWB anchor 104 (R6). The UWB anchors 104 are spaced apart from each other, e.g., spread over the vehicle 102, to increase the ability to distinguish a location when used for trilateration. For example, four of the UWB anchors 104 may be located at respective corners of the vehicle 102 to maximize the horizontal spread of the UWB anchors 104, and the remaining two UWB anchor 104 are located internally to a footprint of the vehicle 102, in many cases at different heights than the corner-mounted UWB anchors 104 to provide a vertical spread. To perform trilateration, computation of the intersection of usually three or more circles or spheres, may provide the location of the detected device. In some situations, it may be possible to obtain a precise location of the detected device using data from two anchors and clever analysis algorithms.

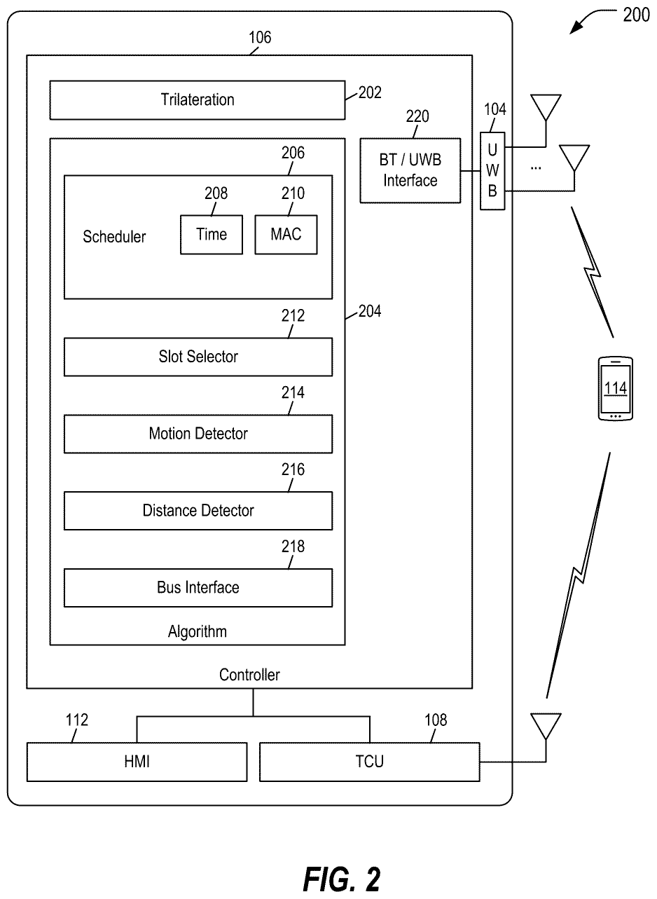

The controller 106 may be a microprocessor-based computing device, e.g., a generic computing device including a processor and a memory, an electronic controller or the like, a field-programmable gate array (FPGA), an application-specific integrated circuit (ASIC), a combination of the foregoing, etc. Typically, a hardware description language such as VHDL (VHSIC (Very High Speed Integrated Circuit) Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. The controller 106 can thus include a processor, a memory, etc. The memory of the controller 106 can include media for storing instructions executable by the processor as well as for electronically storing data and/or databases, and/or the controller 106 can include structures such as the foregoing by which programming is provided. Further details of the controller 106 are discussed with respect to FIG. 2.

The TCU 108 is another control unit of the vehicle 102 that may be utilized for communication over a communications network 110. In an example, TCU 108 may be configured to provide telematics services to the vehicle 102. These services may include, as some non-limiting possibilities, navigation, turn-by-turn directions, vehicle health reports, local business search, accident reporting, and hands-free calling. The TCU 108 may include network hardware configured to facilitate communication between the vehicle 102 and other devices of the perimeter detection system 100. For example, the TCU 108 may include or otherwise access a cellular modem configured to facilitate communication with the communications network 110. The communications network 110 may include one or more interconnected communications networks 110 such as the Internet, a satellite link network, a local area network, and a telephone network, as some non-limiting examples. The communications network 110 may provide communications services, such as packet-switched network services (e.g., Internet access, voice over internet protocol (VoIP) communication services), to devices connected to the communications network 110. For instance, the TCU 108 may access the communications network 110 via connection to one or more cellular towers. In another example, the TCU 108 may access the communications network 110 via a Wi-Fi connection.

The HMI 112 may be configured to provide an interface through which the vehicle 102 occupants may interact with the vehicle 102. The interface may include a touchscreen display, voice commands, and physical controls such as buttons and knobs. The HMI 112 may be configured to receive user input via the various buttons or other controls, as well as provide status information to a driver (including information related to the disclosure, such as whether an object has been detected outside the vehicle 102, the locations of auxiliary devices 114, etc.), such as fuel level information, engine operating temperature information, and current location of the vehicle 102. The HMI 112 may be configured to provide information to various displays within the vehicle 102, such as a center stack touchscreen, a gauge cluster screen, etc. The HMI 112 may accordingly allow the vehicle 102 occupants to access and control various systems such as navigation, entertainment, and climate control.

The auxiliary devices 114 may include portable computing devices such as smart key fobs, mobile phones (e.g., smartphones), wearable devices (e.g., smartwatches, headsets, etc.), tablets, CCC access devices, smart tools, etc. The auxiliary devices 114 are computing devices including respective processors and respective memories. The auxiliary devices 114 may be owned and carried by respective persons who may be operators and/or owners of the vehicle 102.

The auxiliary devices 114 may be configured to operate as access devices (e.g., phone as a key) to provide access to the vehicle 102. In this capacity, the auxiliary devices 114 may perform ranging operations with the UWB anchors 104 of the vehicle 102 to allow the controller 106 to determine proximity and unlock the vehicle 102 when the auxiliary device 114 is within a predetermined threshold distance. Once paired via a secure provisioning process, the auxiliary devices 114 may store digital keys and maintain secure channels for communication with the UWB anchors 104 and controller 106.

The device UWB 116 functionality of the auxiliary devices 114 may include both ranging and radar capabilities. The radar functionality may include transmission and reception of UWB pulses to perform radar sensing in designated time slots. This capability may be utilized by the controller 106 of the vehicle 102 to enable the auxiliary devices 114 to serve as remote radar nodes contributing to the extended perimeter detection. The UWB chipset in the auxiliary devices 114 may support generation of CIRs and may perform preprocessing or pass raw CIR data back to the vehicle 102 depending on the system configuration. For example, the auxiliary devices 114 may apply motion detection algorithms to CIRs by identifying sudden changes in multipath reflections or amplitude thresholds. These algorithms may include peak detection, sliding window comparison, or pattern classification to differentiate motion from noise. The device UWB 116 functionality may be implemented using commercially available UWB chipsets capable of short-range radar operation with low power consumption.

The network controller 118 of the auxiliary device 114 may be configured to wirelessly communicate with the vehicle 102. As some examples, the network controller 118 may manage wireless communications such as BLE (Bluetooth Low Energy), Wi-Fi, and UWB links, and may coordinate synchronization with the vehicle 102 to participate in time-slotted radar transmissions.

The auxiliary devices 114 may execute a perimeter application 120 to enhance participation in the extended UWB radar perimeter system. The perimeter application 120 may provide a user interface for setup and configuration of the auxiliary device 114 as a radar node, including input of the device's physical location relative to the vehicle 102 or activation of automatic location estimation features. The perimeter application 120 may additionally handle communication with the vehicle controller 106, including reception of radar schedules, transmission of radar results, and alert handling. The perimeter application 120 may also provide other functionality such as allowing the user to terminate the detection around the vehicle 102 perimeter, check the auxiliary device 114 out of the extended perimeter detection network, view the status of the detections, etc. In other examples, the configuration functionality may be exposed to users of the vehicle using the HMI 112.

FIG. 2 illustrates further aspects of the controller 106 implementing UWB radar and ranging modes. As shown, the controller 106 may implement a trilateration algorithm 202 and also a radar ranging algorithm 204. The radar ranging algorithm 204 may include a scheduler 206 configured to utilize time scheduler 208 and media access control (MAC) scheduler 210, a slot selector 212, a motion detection 214, a distance detector 216, and a bus interface 218. The controller 106 may also include a Bluetooth/UWB interface 220 for communication with the auxiliary device 114 over Bluetooth and/or UWB. Therefore, the controller 106 may also act as an additional anchor similar to UWB anchors 104. The controller 106 may be in communication through the backend through, e.g., the bus interface 218, with the UWB anchors 104 and may also be in communication with the TCU 108 and the HMI 112.

Ranging mode in the context of UWB refers to the process of measuring the distance between the UWB devices and an object or another UWB device by calculating the time it takes for a signal to travel to and from the object. This mode relies on a time-of-flight (TOF) principle, where the time taken by a UWB signal to travel from the transmitter to the receiver is accurately measured, enabling precise calculation of distances. Ranging mode requires both the device that is performing the ranging and the devices which is being ranged to have a UWB transceiver. Ranging mode is helpful for applications that require accurate location tracking, such as vehicle access systems, where it helps in determining the exact position of the user's auxiliary device 114 relative to the vehicle 102.

Radar mode, on the other hand, involves using UWB technology to detect and track the presence and movement of objects around the vehicle 102. In this mode, UWB anchors 104 emit radar signals that bounce off nearby objects and return to the sensors. The objects that are being detected in this way do not need to have a UWB transceiver to be detected. By analyzing the returned signals, the system can identify the size, shape, and movement patterns of these objects. For example, CIR may be used between the UWB anchors 104 to characterize the wireless environment of the vehicle 102. The CIR may describe how a wireless channel responds to an impulse signal, which is a very short signal, typically a 1-2 nanosecond pulse. The CIR captures the amplitude, phase, and delay of the multipath components that are sent from a transmitter and received by a receiver after reflecting, refracting, or scattering within the environment. By observing the multipath components of the CIR caused by scattering at target objects, movement of objects in and around the vehicle 102 may be detected. Changes in CIR over time, particularly in amplitude or phase shift, may indicate motion in the monitored environment. Radar mode is particularly useful for enhancing detection of approaching animals, persons, vehicles 102, cyclists, or pedestrians, even when the vehicle 102 is in a low-power state. This mode allows the system to provide real-time alerts and take preventive or remediating actions.

The trilateration algorithm 202 may implement the ranging mode by performing a computation of the intersection of three or more circles or spheres. The UWB anchors 104 may be configured to transmit and receive signals (within signal power thresholds) over UWB channel frequencies (e.g., UWB channel 9 (7.737-8.236 GHz) to Channel 5 (6.240-6.739 GHz) or other possible channels that are adopted by the UWB standard). Under ideal radio frequency (RF) conditions, e.g., when the auxiliary device 114 is located within the line of sight (LOS), three UWB anchors 104 may be sufficient in locating the auxiliary device 114, i.e., the initiator, and thereby enabling trilateration-based localization of the user through responder-to-initiator distance ranging.

The radar ranging algorithm 204 is configured to utilize the UWB anchors 104 to implement UWB radar and ranging. The radar ranging algorithm 204 utilizes the scheduler 206 to schedule which of the UWB anchors 104 are to operate in ranging mode and which of the UWB anchors 104 are to operate in radar mode. The scheduler 206 includes a time scheduler 208 that handles timing scheduling based on the position of the object to be tracked. The scheduler 206 also includes a MAC scheduler 210 that selects the ranging slots for radar operation. The radar ranging algorithm 204 utilizes the slot selector 212 to determine which wireless slots to use for radar and which to use for ranging. The motion detection 214 is configured to detect relative changes in position of detected objects over time with reference to the location of the vehicle 102. The distance detector 216 is configured to detect distances of detected objects from the vehicle 102.

The bus interface 218 may be configured to allow the controller 106 to transmit and receive data through a vehicle bus such as a controller area network (CAN) bus, Ethernet, WiFi, Local Interconnect Network (LIN), onboard diagnostics connector (OBD-II), and/or by any other wired or wireless communications network 110. The controller 106 may be communicatively coupled to the UWB anchors 104, the TCU 108, the HMI 112, and/or other components via the communications network 110. In some examples, the bus interface 218 may expose one or more ports to allow for the wired connection of auxiliary devices 114 to the vehicle 102. These ports may be located on the exterior of the vehicle in an example. In another example, the ports may be exposed via a wiring harness.

The BLUETOOTH/UWB interface 220 may be configured to allow the controller 106 to transmit signals wirelessly through the UWB communications that are used by the UWB anchors 104. The controller 106 may also have a BLUETOOTH (BT) or BLUETOOTH LOW ENERGY (BLE) transceiver. This transceiver may be used to communicate control signaling during the ranging mode typically performed with devices that are part of the digital key protocol (e.g., smart phones, key fobs) but also with devices such as the auxiliary devices 114 discussed herein. In other examples, the BLUETOOTH/UWB interface 220 functionality may be implemented in whole or in part using the TCU 108. In an example, the controller 106 may use the connectivity of the TCU 108 for BLE.

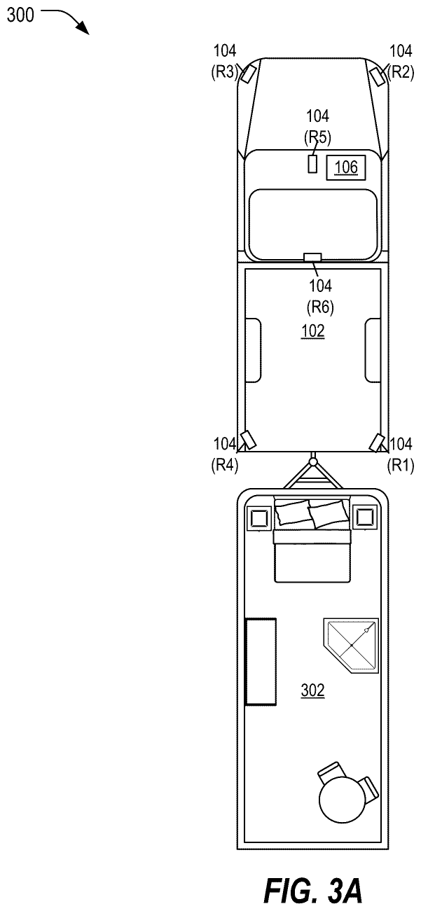

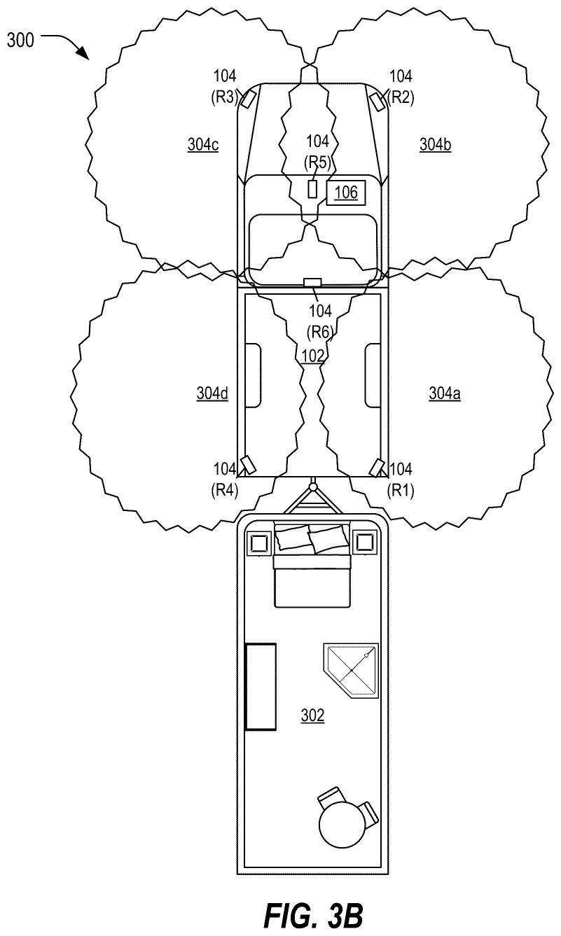

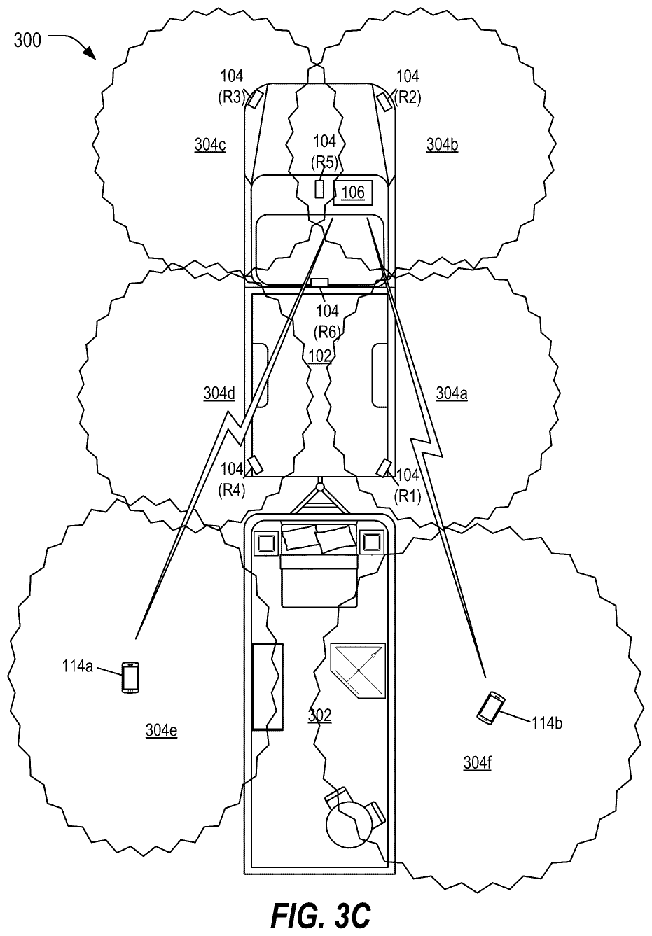

FIG. 3A illustrates an example of the vehicle 102 with a trailer 302 connected at the rear. The trailer 302 refers to an auxiliary transport structure hitched to the vehicle 102, which may include enclosed trailers 302, camper trailers 302, utility trailers 302, or other towed platforms.

In some examples, the presence of the trailer 302 alters the geometry and spatial layout of the area surrounding at least the rear of vehicle 102, potentially obscuring or limiting the effectiveness of onboard UWB coverage from the UWB anchors 104. The trailer 302 may also include additional compartments or surfaces that create line-of-sight obstructions or multipath effects that affect the propagation of UWB. As a result, detection of motion or presence behind or around the trailer 302 using only vehicle-mounted UWB anchors 104 may be insufficient or unreliable.

FIG. 3B illustrates the example of the vehicle 102 with the trailer 302 connected at the rear and UWB coverage areas 304 provided by the UWB anchors 104 of the vehicle 102. As shown, a first coverage area 304a is provided by the first UWB anchor 104 (R1), a second coverage area 304b is provided by the second UWB anchor 104 (R2), a third coverage area 304c is provided by the third UWB anchor 104 (R3), and a fourth coverage area 304d is provided by the fourth UWB anchor 104 (R4). In this example, the fifth UWB anchor 104 (R5) and the sixth UWB anchor 104 (R6) do not participate in the detected because they are internal anchors and would not be as useful in detecting movement outside of the vehicle 102.

As shown, the collective UWB coverage area 304 indicate the area surrounding the vehicle 102 within which radar detection can be performed based solely on the signals emitted by the vehicle-mounted UWB anchors 104. Due to physical limitations such as the occlusion of signals by the body of the trailer 302 and the finite field of view of the UWB antennas, the UWB coverage area 304 may taper off near the rear of the trailer 302 or may not fully enclose the spatial volume of interest (e.g., a campsite or a storage area behind the trailer 302). This results in potential blind spots in the radar perimeter where motion detection 214 is degraded or unavailable, increasing the possibility of missed detection events.

FIG. 3C illustrates an example of the vehicle 102 with a trailer 302 connected at the rear with the addition of auxiliary devices 114 in communication with the vehicle 102 to provide additional coverage areas 306. One or more auxiliary devices 114 (here, two auxiliary devices 114a, 114b) are placed at selected positions around the trailer 302. These placements may include along the sides of the trailer 302, on or near the rear corners of the trailer 302, within a tent area, or at a perimeter location determined by the user.

These auxiliary devices 114 may be securely paired with the vehicle 102 via the perimeter application 120 using BLE and/or UWB protocols and may be configured to participate in time-scheduled radar sensing as coordinated by the controller 106. As further shown, a fifth coverage area 304e is provided by the auxiliary device 114a and a sixth coverage area 304f is provided by the auxiliary device 114b. These additional coverage areas 304e-f represent extended UWB radar detection zones established by the auxiliary devices 114 operating as supplemental radar nodes. The controller 106 may fuse data from the UWB anchors 104 and the auxiliary devices 114 to generate a comprehensive detection map, enabling improved situational awareness, enhanced perimeter monitoring, and dynamic response capabilities in scenarios involving trailers 302, outdoor camping, or remote asset monitoring.

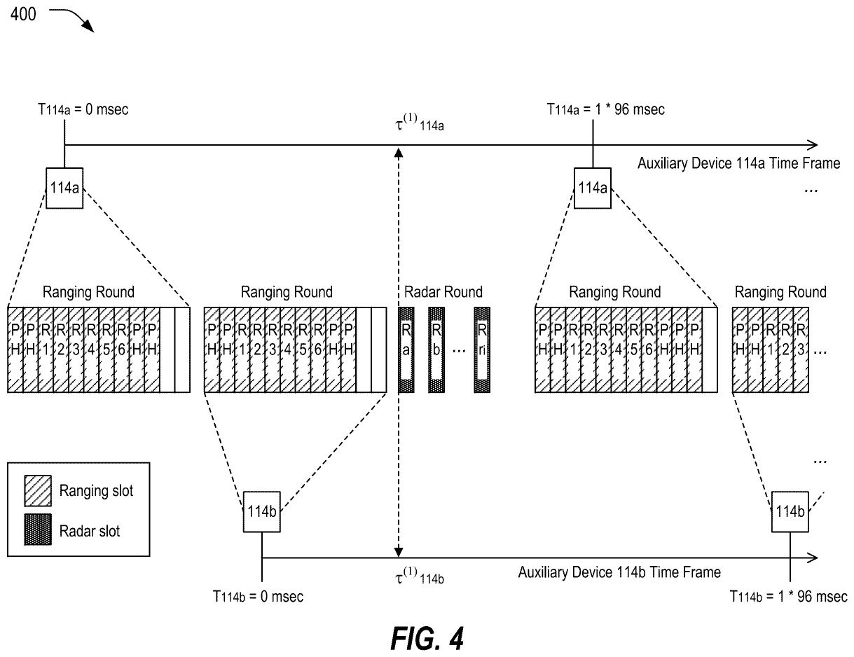

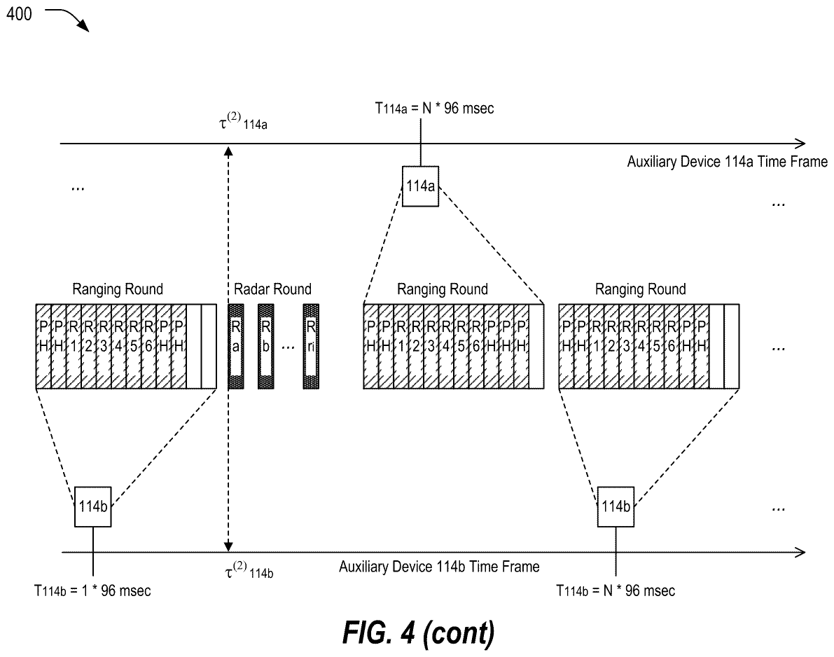

FIG. 4 illustrates an example scheduling 400 of ranging and radar sessions between the UWB anchors 104 and the auxiliary devices 114. Ranging time slots are shown as diagonal hatching, while radar timeslots are shown as dotted hatching. In this example, both of the auxiliary devices 114a, 114b from FIG. 3C are paired with the vehicle 102 and are participating in the ranging and radar. These auxiliary devices 114a, 114b are also connected, in this example, via BLE to the controller 106 (as shown by the wireless connections in FIG. 3C.) While two auxiliary devices 114a, 114b are discussed in FIGS. 3C and 4, it should be noted that more or fewer auxiliary devices 114 may be used.

The controller 106 may communicate to the UWB anchors 104 and the auxiliary devices 114 which frames will be used as a radar round, as well as the assignment of radar slots per auxiliary device 114. For example, the controller 106 may transmit the radar schedule to each auxiliary device 114 over BLE, e.g., also including timing synchronization data. In some examples, the schedule conforms to a timing format defined by the CCC standard to ensure slot alignment and evade interference. Communication between the controller 106 and the anchors UWB anchors 104 R1-R4 may be performed through a bus of the vehicle 102, although this communication could also be wireless in other examples. It should again be noted that, e.g., to reduce power consumption, R5 and R6 are not part of the schedule since they are internal UWB anchors 104 and may not be useful in detection outside of the vehicle 102. However, R5 and R6 may be activated in case of entry into the vehicle interior being anticipated responsive to detection of motion outside the vehicle 102.

Referring more specifically to the example scheduling 400, the CCC defines ranging sessions controlled by a device called an initiator, typically an auxiliary device 114. A handshake between the auxiliary device 114 and the UWB anchors 104 may occur during a specific ranging round within a time interval called a ranging block, which repeats periodically.

A repeating set of rounds may be used by the controller 106 for performing the ranging and radar. The scheduling 400 may be determined by the scheduler 206 of the controller 106 based on the quantity of auxiliary devices 114 that are paired, the number of UWB anchors 104 being used, etc. The scheduler 206 defines the ranging rounds and radar rounds to occur at specific intervals to evade interference and ensure orderly participation of the auxiliary devices 114 and UWB anchors 104. In the illustrated example, a complete cycle includes three main segments: a first ranging round (initiated by auxiliary device 114a at T₁₁₄ₐ=0 milliseconds), where the subscript 114a indicates that this is the local time at auxiliary device 114a, a second ranging round (initiated by auxiliary device 114b at T_{114b}=0 milliseconds), where the subscript 114b indicates that this is the local time at auxiliary device 114b which in general is different from the local time at auxiliary device 114a, and two radar rounds (e.g., involving auxiliary devices 114a, 114b, and an anchor 104 Rᵢ, the first radar round commencing shortly after the first ranging round of auxiliary device 114b and the second radar round commencing after the second ranging round of auxiliary device 114a).

Note that in the example of CCC digital key the ranging round period is an integer multiple of 96 milliseconds and it may be different between devices 114a and 114b. It should be noted that the UWB anchors 104 on the vehicle are aware of both timing of the auxiliary devices 114a and 114b because they are participating in ranging with both.

The ranging round slots enable the UWB anchors 104 and the auxiliary devices 114 to perform secure two-way TOF measurements to determine location. The radar round includes a different allocation of radar-specific slots, which are dedicated to transmitting and receiving UWB pulses for motion sensing and environmental awareness. The full cycle may be expressed as a periodicity at auxiliary device 114a or at auxiliary device 114b. For example, when communicating the radar schedule to auxiliary device 114a, the scheduler 206 will use the time instant τ₁₁₄ₐ. Similarly, when communicating the radar schedule to auxiliary device 114b, the scheduler 206 will use the time instant t_{114b}+2 Tₛₗₒₜ, where Tₛₗₒₜ is a time period in which either the ranging or radar transmission and reception must take place. This slot timing may be on the order of 2 milliseconds, but may smaller or larger. A shift of 2 slots may be provided, because the radar transmission of device 114b occurs 2 slots after the radar transmission of device 114a.

When communicating the timing of the radar transmission to one of the anchors 104, e.g., Rᵢ, the scheduler may use either the auxiliary device 114a or the auxiliary device 114b timeframe, depending on which auxiliary device 114 the anchor Rᵢ can communicate with. Thus, the timing communicated to the UWB anchor 104 Ri can be τ₁₁₄ₐ+4 Tₛₗₒₜₛ or t_{114b}+4 Tₛₗₒₜ. The scheduler may schedule a radar transmission of an auxiliary device 114 or an UWB anchor 104 separately as shown in the figure with auxiliary device 114a at time τ⁽¹⁾₁₁₄ₐ. The times are shown as first instances of radar transmission and the subsequent transmissions will be send periodically with respect to the first transmission. The scheduling 400 as shown is just an example, and other options are possible.

The alternating use of auxiliary devices 114a and 114b for initiating ranging rounds improves spatial diversity and ensures that localized measurements are obtained from multiple physical perspectives around the trailer 302 or other extended coverage zone. Additionally, the radar round can be dynamically inserted between ranging blocks and may be assigned to either or both auxiliary devices 114a, 114b depending on the relative signal quality, device orientation, or past detection history. The radar data acquired during these slots (e.g., CIR measurements) may be post-processed on the device into object detections, or in other examples, sent directly to the controller 106 for centralized analysis and fusion.

In another variation, the trailer 302 itself could be built or upfit with UWB anchors 104. In some of these examples, these additional UWB anchors 104 may be wired via hitch of the vehicle 102 to the vehicle 102 bus for communication with the controller 106 (e.g., via ports to the bus interface 218). Or in other examples, these UWB anchors 104 may wirelessly communicate with the controller 106.

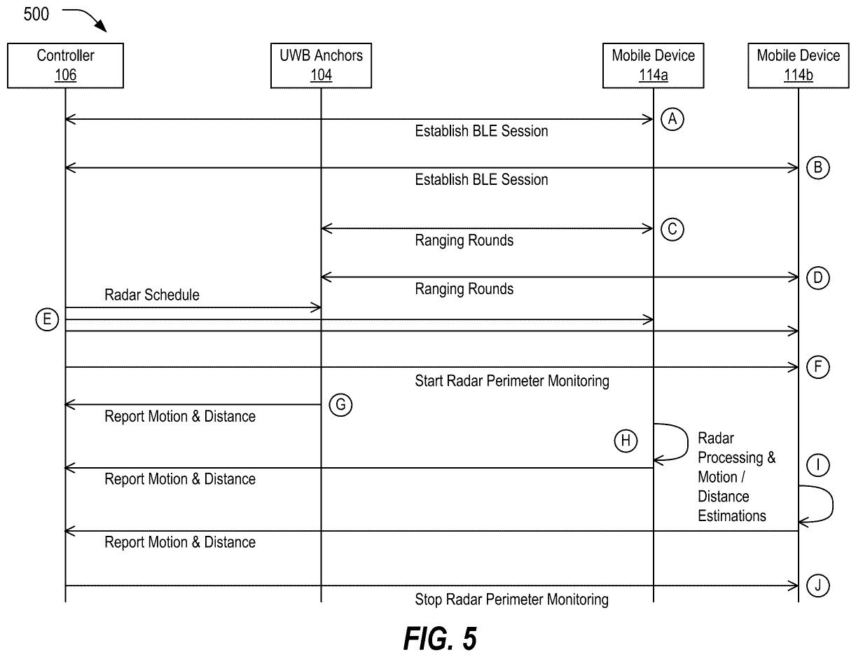

FIG. 5 illustrates an example data flow 500 for the operation of the controller 106 in the context of the perimeter detection system 100. The illustrated data flow 500 is performed between the controller 106, UWB anchors 104, and auxiliary devices 114a, 114b during radar perimeter monitoring. Each index (A) through (H) corresponds to a stage in the setup, operation, and shutdown of the extended radar detection functionality. While two auxiliary devices 114a, 114b are discussed to be consistent with the other examples, it should be noted that more or fewer auxiliary devices 114 may be used.

At index (A), the controller 106 establishes a communication session with the auxiliary device 114a. In an example, the controller 106 may initiate and complete a BLE handshake with auxiliary device 114a. This handshake may include mutual authentication and provisioning of cryptographic keys, enabling secure data exchange. The BLE session provides a control and configuration channel between the controller 106 and auxiliary device 114a, allowing scheduling and status commands to be exchanged.

At index (B), the controller 106 establishes a communication session with the auxiliary device 114b. In an example, the controller 106 similarly establishes a BLE session with auxiliary device 114b. This second BLE session ensures that both remote radar-capable devices are securely connected to the vehicle's controller 106 and available for perimeter extension operations. Each BLE session may include parameters indicating the radar capability, location metadata, or preferred scheduling options for the corresponding device.

At index (C), the controller 106 establishes the performance of ranging rounds with the auxiliary device 114a. In an example, the controller 106 instructs the auxiliary device 114a to initiate one or more ranging rounds with the UWB anchors 104. These ranging operations allow the controller 106 to accurately localize auxiliary device 114a within the coordinate frame of the vehicle 102. This positioning data may also be used to verify whether the auxiliary device 114 is properly located to provide supplemental radar coverage.

At index (D), the controller 106 establishes the performance of ranging rounds with the auxiliary device 114b. In an example, a similar sequence of ranging rounds is initiated with auxiliary device 114b. The use of ranging from multiple auxiliary devices 114 improves spatial resolution, especially in cases where coverage by the UWB anchors 104 is limited or partially obstructed by objects such as the trailer 302.

At index (E), the controller communicates radar schedule configuration to the UWB anchors 104 and auxiliary devices 114 (e.g., the auxiliary devices 114a and 114b). An example scheduling 400 is discussed above with respect to FIG. 4.

At index (F), the controller 106 starts radar perimeter monitoring. This command may be broadcast to the UWB anchors 104 and to the auxiliary devices 114a, 114b, and may include a radar schedule, timeslot assignments, and data reporting configurations. The command may also define a detection perimeter or specify parameters for sensitivity, reporting thresholds, or motion classification (e.g., human vs. animal vs. object).

At index (G), the controller 106 receives motion and distance measurements as reported by the UWB anchors 104. In an example, the controller 106 begins receiving radar data from the UWB anchors 104. This data may include processed motion events or raw CIRs, depending on the capabilities of the anchors and system configuration. The controller 106 may use this information to monitor the base vehicle perimeter and compare against input from the auxiliary devices 114.

At index (H), the controller 106 receives motion and distance measurements as reported by the auxiliary device 114a. In an example, the auxiliary device 114a performs radar processing, including generation of CIRs and execution of motion detection 214 and distance estimation algorithms. The resulting detection events, including one or more of motion vectors, timestamps, and distance metrics, are reported to the controller 106 over the BLE connection. This may occur in near real-time, or in batch form if power-saving modes are enabled.

At index (I), the controller 106 receives motion and distance measurements as reported by the auxiliary device 114b. In an example, the auxiliary device 114b similarly performs radar sensing and sends results to the controller 106. The inputs from both auxiliary devices 114 may be combined by the controller 106 with data from the UWB anchors 104 to build a unified radar coverage map. In some cases, the controller 106 may apply signal fusion or filtering techniques to reduce noise and resolve redundant or overlapping detection events.

At index (J), the controller 106 stops radar perimeter monitoring. In an example, the radar perimeter monitoring continues until a termination condition is met, such as vehicle ignition, user input via the HMI 112, expiration of a timer, or loss of signal from one or more auxiliary devices 114. When such a condition occurs, the controller 106 sends a stop command to terminate radar monitoring, thereby releasing timeslot allocations and minimizing energy consumption on the mobile devices and vehicle radar systems. It should be noted that while the radar schedule (E) is shown as being sent before the start of radar monitoring at index (F), the controller 106 may send updates of the radar schedule (E) between the start of radar monitoring at index (F) and the stop of radar monitoring at index (J).

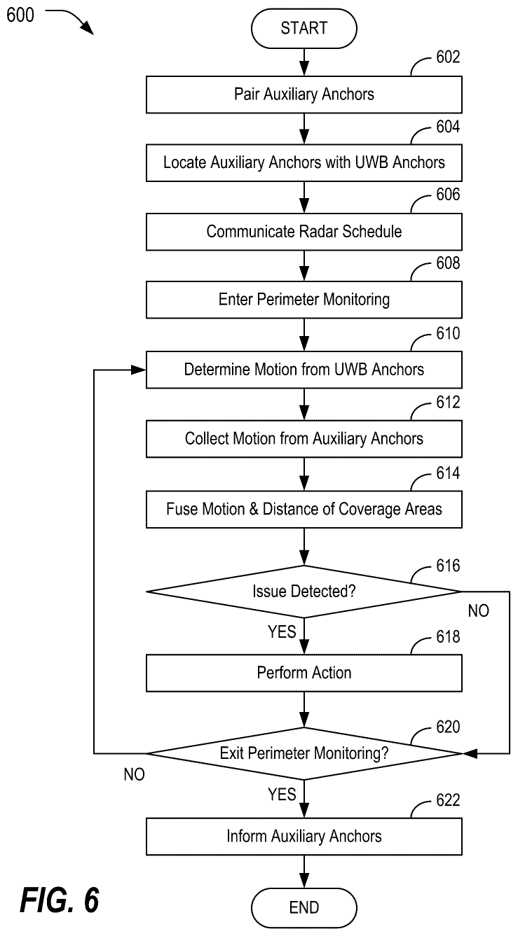

FIG. 6 illustrates an example process 600 for extending UWB perimeter detection provided by a vehicle 102 using UWB-enabled auxiliary devices 114. In an example, the process 600 may be performed by the controller 106 in the context of the UWB anchors 104, auxiliary devices 114, and other components of the perimeter detection system 100.

At operation 602, the controller 106 pairs with auxiliary devices 114. In an example, the controller 106 initiates a BLE handshake with each auxiliary device 114 within range. This handshake includes mutual authentication, provisioning of encryption keys, and exchange of capability data. Once paired, each auxiliary device 114 may be configured for secure UWB communication, enabling its use as an auxiliary radar node within the perimeter detection system 100. The pairing may be user-initiated via the HMI 112 or may be automatically triggered upon proximity detection of a previously bonded device.

At operation 604, the controller 106 locates the auxiliary devices 114. In an example, the controller 106 performs a series of ranging rounds with each auxiliary device 114 using the UWB anchors 104. The resulting TOF measurements allow the controller 106 to compute the position of each device using trilateration algorithms 202. This location data is used to determine whether the auxiliary devices 114 are suitably placed to fill gaps in the radar coverage perimeter. In other configurations, manual entry of position coordinates, GNSS-based positioning, or IMU tracking from the auxiliary devices 114 may be used to augment or replace UWB-based localization.

At operation 606, the controller 106 determines a non-overlapping schedule of the radar rounds taking into account the established ranging rounds with the auxiliary devices 114 and communicates this radar schedule to the anchors 104 and to the auxiliary devices 114. The controller 106 generates a radar schedule which includes dedicated timeslots for radar operations by the UWB anchors 104 and the auxiliary devices 114. This schedule is transmitted to each participant node, along with any additional configuration data such as radar sensitivity, reporting intervals, or thresholds for the motion detection 214.

At operation 608, the controller 106 enters perimeter monitoring. In an example, the controller 106 begins active monitoring of the area surrounding the vehicle 102 based on a defined detection perimeter. The defined perimeter may be determined by the controller 106 using a combination of user input, ranging measurements, or predefined coverage zones. In some examples, the perimeter is automatically computed based on the locations of auxiliary devices 114 relative to the vehicle 102. In some examples, the perimeter may be determined based on sensing of the surroundings of the vehicle 102 and/or baselining via radar. For instance, an ego vehicle 102 may park and activate radar mode based on an initial broad perimeter, but if another vehicle 102 shows up and parks next to it, the ego vehicle 102 may reduce the perimeter size to be closer to the ego vehicle. In another example, the perimeter may be increased if a vehicle that was parked next to the ego vehicle drives away. In yet another example, a reduction in the perimeter may be performed if the user parks next to a wall.

At operation 610, the controller 106 determines motion using the built-in UWB anchors 104. For example, during designated radar slots, the UWB anchors 104 transmit and receive UWB pulses to capture CIRs. These responses are analyzed locally or transmitted to the controller 106 for the motion detection 214. The detected movement is characterized by position, magnitude, and time, and may be used to identify changes within the base UWB coverage areas 304 provided by the vehicle-mounted UWB anchors 104.

At operation 612, the controller 106 collects information indicative of motion from the auxiliary devices 114. For example, each auxiliary device 114 performs radar sensing during its assigned timeslots, either pre-processing the CIRs locally to generate motion events or sending raw data back to the controller 106. The communication of results may occur over BLE or another wireless link and may include detection metadata such as timestamp, object direction, motion vector, and estimated distance. In the case of auxiliary sensors wired into the trailer 302, the results may be communicated over a wired connection from the trailer 302 to the vehicle 102.

At operation 614, the controller 106 fuses the motion information from the UWB anchors 104 and the auxiliary devices 114 to provide coverage across the extended UWB coverage areas 304. For example, the controller 106 performs data fusion to combine motion and distance detections across multiple sources. This may involve aligning detection timestamps, weighting based on sensor accuracy or position, and filtering out noise or redundant readings. This fusion of motion data extends the situational awareness of the perimeter detection system 100 into regions not fully covered by the UWB anchors 104 alone. Accordingly, the fused results provide a unified perimeter motion map used to monitor for events.

At operation 616, the controller 106 determines whether an issue is detected. For example, the controller 106 evaluates the fused sensor data to identify motion patterns consistent with an event of interest. These criteria may include unauthorized movement within a restricted zone, repeated motion near the trailer 302, or approach of a person or animal. If an issue is detected, the process proceeds to operation 618. If no issue is detected, the process continues to operation 620 to continue monitoring.

At operation 618, the controller 106 performs an action. For example, based on the nature and location of the detected issue, the controller 106 may execute a predefined response such as activating lights in the direction of the motion, sounding an alarm, sending a notification to the user's mobile device, recording video using onboard cameras, or contacting priority services. The specific response may be configured by the user via the HMI 112 or a companion application on the auxiliary device 114.

At operation 620, the controller 106 determines whether to exit perimeter monitoring. For example, exit conditions may include ignition of the vehicle 102, user command, disconnection of one or more auxiliary devices 114, or elapsing of a pre-set monitoring duration. If perimeter monitoring is to continue, the process returns to operation 610. Otherwise, the process proceeds to operation 622.

At operation 622, the controller 106 informs the auxiliary devices 114 to discontinue monitoring. In an example, the controller 106 transmits a termination command to the auxiliary devices 114, instructing them to stop radar transmissions and release radar schedule allocations. This reduces power consumption on the auxiliary devices 114 and conserves processing resources of the vehicle 102. The BLE communication sessions may remain active or may be suspended based on user settings or power optimization strategies. After operation 622, the process 600 ends.

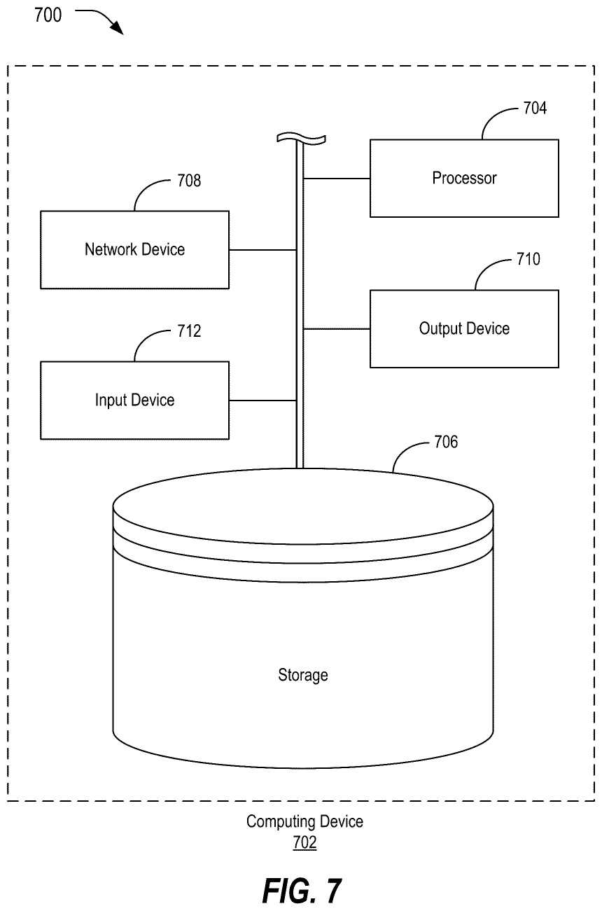

FIG. 7 illustrates an example computing device 702 for implementing aspects of UWB radar and ranging. Referring to FIG. 7, and with reference to FIGS. 1-6, the vehicle 102, UWB anchors 104, controller 106, TCU 108, communications network 110, HMI 112, and auxiliary devices 114 may include examples of such computing devices 702. Computing devices 702 generally include computer-executable instructions, where the instructions may be executable by one or more computing devices 702. Computer-executable instructions may be compiled or interpreted from computer programs created using a variety of programming languages and/or technologies, including, without limitation, and either alone or in combination, Java™, C, C++, C #, Visual Basic, Python, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

As shown, the computing device 702 may include a processor 704 that is operatively connected to a storage 706, a network device 708, an output device 710, and an input device 712. It should be noted that this is merely an example, and computing devices 702 with more, fewer, or different components may be used.

The processor 704 may include one or more integrated circuits that implement the functionality of a central processing unit (CPU) and/or graphics processing unit (GPU). In some examples, the processors 704 are a system on a chip (SoC) that integrates the functionality of the CPU and GPU. The SoC may optionally include other components such as, for example, the storage 706 and the network device 708 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 704 executes stored program instructions that are retrieved from the storage 706. The stored program instructions, accordingly, include software that controls the operation of the processors 704 to perform the operations described herein. The storage 706 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random access memory (RAM) that stores program instructions and data during operation of the perimeter detection system 100.

The GPU may include hardware and software for display of at least two-dimensional (2D) and optionally three-dimensional (3D) graphics to the output device 710. The output device 710 may include a graphical or visual display device, such as an electronic display screen, projector, printer, or any other suitable device that reproduces a graphical display. As another example, the output device 710 may include an audio device, such as a loudspeaker or headphone. As yet a further example, the output device 710 may include a tactile device, such as a mechanically raiseable device that may, in an example, be configured to display braille or another physical output that may be touched to provide information to a user.

The input device 712 may include any of various devices that enable the computing device 702 to receive control input from users. Examples of suitable input devices 712 that receive human interface inputs may include keyboards, mice, trackballs, touchscreens, microphones, graphics tablets, and the like.

The network devices 708 may each include any of various devices that enable the described components to send and/or receive data from external devices over networks. Examples of suitable network devices 708 include an Ethernet interface, a Wi-Fi transceiver, a cellular transceiver, or a BLUETOOTH or BLE transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A method for extending ultrawide band (UWB) perimeter detection provided by a vehicle using UWB-enabled auxiliary devices, the method comprising:
receiving, to a controller of a vehicle from one or more auxiliary devices located outside of and in communication with the vehicle, radar sensing data indicative of motion detected by each of the respective one or more auxiliary devices;
receiving, from one or more UWB anchors located on the vehicle, UWB radar data indicative of motion detected by the UWB anchors;
fusing the radar sensing data from the one or more auxiliary devices with the UWB radar data from the one or more UWB anchors to detect motion within a defined perimeter around the vehicle; and
in response to detecting motion within the defined perimeter, initiating a predefined response action.

2. The method of claim 1, further comprising establishing a BLUETOOTH Low Energy (BLE) communication session with each of the one or more auxiliary devices located outside the vehicle, the BLE communication session being used for sending commands to the respective one or more auxiliary devices and for receipt of the radar sensing data, the commands including a command to initiate use of the one or more auxiliary devices for radar sensing.

3. The method of claim 1, further comprising identifying physical locations of the one or more auxiliary devices with respect to the vehicle using the one or more UWB anchors.

4. The method of claim 1, further comprising:
determining a schedule that includes radar time slots for the one or more auxiliary devices; and
transmitting the schedule to the one or more auxiliary devices, wherein the one or more auxiliary devices utilize the schedule to time operation of radar rounds by the one or more auxiliary devices.

5. The method of claim 1, wherein the predefined response action includes one or more of:
activating a light of the vehicle in a direction corresponding to the detected motion;
sounding a horn of the vehicle;
initiating a communication with priority services; and/or
displaying a message via a human-machine interface (HMI) of the vehicle.

6. The method of claim 1, wherein the radar sensing data comprises channel impulse response (CIR) data received from each auxiliary device, and wherein the controller analyzes amplitude, delay, or multipath characteristics of the CIR data to determine a presence, motion, or trajectory of an object.

7. The method of claim 1, wherein the radar sensing data is processed locally by each auxiliary device to detect motion, and the detected motion is transmitted to the controller.

8. The method of claim 1, further comprising transmitting a stop command to the one or more auxiliary devices to terminate radar perimeter monitoring based on a condition, the condition including vehicle ignition, timeout expiration, or received user input.

9. A vehicle for extending ultrawide band (UWB) perimeter detection using UWB-enabled auxiliary devices, comprising:
one or more UWB anchors configured to monitor coverage areas outside the vehicle; and
a controller, configured to:
receive from one or more auxiliary devices located outside of and in communication with the vehicle, radar sensing data indicative of motion detected by each of the respective one or more auxiliary devices,
receive, from the one or more UWB anchors, UWB radar data indicative of motion detected by the UWB anchors,
fuse the radar sensing data from the one or more auxiliary devices with the UWB radar data from the one or more UWB anchors to detect motion within a defined perimeter around the vehicle, and
in response to detecting motion within the defined perimeter, initiating a predefined response action.

10. The vehicle of claim 9, wherein at least one of the auxiliary devices includes a UWB sensor mounted on a trailer coupled to the vehicle.

11. The vehicle of claim 9, wherein at least one of the auxiliary devices includes a mobile phone paired to the vehicle.

12. The vehicle of claim 9, wherein the controller is further configured to establish a BLE communication session with each of the one or more auxiliary devices located outside the vehicle, the BLE communication session for use in sending commands to the respective one or more auxiliary devices and for receipt of the radar sensing data, the commands including a command to initiate use of the one or more auxiliary devices for radar sensing.

13. The vehicle of claim 9, wherein the controller is further configured to identify physical locations of the one or more auxiliary devices with respect to the vehicle using the one or more UWB anchors.

14. The vehicle of claim 9, wherein the controller is further configured to:
determine a schedule that includes radar time slots for the one or more auxiliary devices; and
transmit the schedule to the one or more auxiliary devices, wherein the one or more auxiliary devices utilize the schedule to time operation of radar rounds by the one or more auxiliary devices.

15. The vehicle of claim 9, wherein the predefined response action includes one or more of to:
activate a light of the vehicle in a direction corresponding to the detected motion;
sound a horn of the vehicle;
initiate a communication with priority services; and/or
display a message via a human-machine interface (HMI) of the vehicle.

16. The vehicle of claim 9, wherein the radar sensing data comprises channel impulse response (CIR) data received from each auxiliary device, and the controller is further configured to analyze amplitude, delay, or multipath characteristics of the CIR data to determine a presence, motion, or trajectory of an object.

17. The vehicle of claim 9, wherein the radar sensing data is processed locally by each auxiliary device to detect motion, and the controller is further configured receive information indicative of the motion from the detecting auxiliary device.

18. The vehicle of claim 9, wherein the controller is further configured to transmit a stop command to the one or more auxiliary devices to terminate radar perimeter monitoring based on a condition, the condition including vehicle ignition, timeout expiration, or received user input.

19. A non-transitory computer-readable medium comprising instructions for extending ultrawide band (UWB) perimeter detection provided by a vehicle using UWB-enabled auxiliary devices that, when executed by one or more computing devices, cause the one or more computing devices to perform operations including to:
receive from one or more auxiliary devices located outside the vehicle, radar sensing data indicative of motion detected by each of the respective one or more auxiliary devices;
receive, from one or more UWB anchors, UWB radar data indicative of motion detected by the UWB anchors;
fuse the radar sensing data from the one or more auxiliary devices with the UWB radar data from the one or more UWB anchors to detect motion within a defined perimeter around the vehicle; and
in response to detecting motion within the defined perimeter, initiating a predefined response action.

20. The non-transitory computer-readable medium of claim 19, wherein the predefined response action includes one or more of to:
activate a light of the vehicle in a direction corresponding to the detected motion;
sound a horn of the vehicle;
initiate a communication with priority services; and/or
display a message via a human-machine interface (HMI) of the vehicle.
